(19) United States
(12) Patent Application Publication
(10) Pub. No.: US 2008/0172532 A1
(43) Pub. Date: Jul. 17, 2008

(54) Apparatus for Performing and Coordinating Data Storage Functions

(75) Inventors: Mukund T. Chavan, Alameda Country, CA (US); Ravindra S. Shenoy, Santa Clara County, CA (US); Tony W. Gaddis, Santa Clara Country, CA (US)

Correspondence Address: J. Davis Gilmer, 1185B Minnesota, San Jose, CA, 95125, US

(73) Assignee: Aarohi Communications , Inc., a corporation

(21) Appl. No.: 10/569,322

(22) PCT Filed: Feb. 4, 2005
(86) PCT No.: PCT/US2005/003496

§ 371 Date: Feb. 17, 2006

(51) Int. Cl. G06F 12/00

(52) U.S. Cl. 711/148; 711/E12.001

(57) ABSTRACT

A storage processor is constructed on or within an interconnected circuit (IC) chip. The storage processor has a plurality of ports operable to send and/or receive messages to/from storage devices. An output indication circuit is associated with each output port. The indication circuit indicates that data is ready to be transmitted to a storage device from the particular output port. A crossover circuit is interposed between the ports. The crossover circuit has a memory that can store data. When data is received at a port, the storage processor can store the incoming data to the crossover circuit. A memory is also present on the chip. The memory holds data that relates incoming data to outgoing data. Thus, when data comes into the storage processor, the storage processor can determine a specific course of action for that data based upon the information stored in this memory. The chip also has a plurality of processing sub-units coupled to the crossover switch. Based upon information in the memory, the processing sub units can access and change the data stored in the crossover switch. The sub-units and the ports themselves can relay information via the output indication circuits that specify that the data or the transformed data is ready to be sent from the particular port associated with the output indication circuit. In response to the information on the output indication circuit, a port can then send the data or the transformed data from the crossover switch to a particular storage device. The data in the memory is used to specify the particular device or devices to which the data is sent.

### FIELD OF THE INVENTION

The present invention is directed to storage and manipulation of electronic data. In particular the present apparatus is directed to a storage processor that performs many data storage and manipulation functions in a dynamic and programmable manner.

### DESCRIPTION OF THE ART

As companies rely more and more on e-commerce, online transaction processing, and databases, the amount of information that needs to be managed and stored can intimidate even the most seasoned of network managers. While servers do a good job of storing data, their capacity is limited, and they can become a bottleneck if too many users try to access the same information. Instead, most companies rely on peripheral storage devices such as magnetic disks, tape libraries, Redundant Arrays of Independent Disk systems (RAIDs), and even optical storage systems. These storage devices are effective for backing up data online and storing large amounts of information. Additionally, a need may arise for a full time mirror, so that the data may be accessed as a live copy at many different points in an organization. Or, shadow copies might have to be maintained so that a catastrophic failure may be replaced by a fully coherent representation of the lost system within a short time.

But as server farms increase in size, and as companies rely more heavily on data-intensive applications such as multimedia, the traditional storage model isn't quite as useful. This is because access to these peripheral devices can be slow, and it might not always be possible for every user to easily and transparently access each storage device. In the context of this document, a storage device can refer lo either data sources, data sinks, or intermediate nodes in a network that couples the sources or sinks.

Network storage can be implemented where multiple storage media are coupled directly to a network. However, in large entities, this presents a downside due to is the lack of cohesion among storage devices. While disk arrays and tape drives are on a local area network (LAN), managing the devices can prove challenging since they are separate entities and are not logically tied together. Other problems are present when the devices are inter-coupled with devices over a wide area local network (WAN), or through interconnected networks. Policies to allocate and manage the various storage media are problematic due to the interconnections between the devices. Storage facilities potentially have dozens or even hundreds of servers and devices. Since most high level storage functions traditionally require interaction with or modification of at least one end of every transaction, this makes the task of implementing a high level functionality of storage practices very unwieldy.

Allocation and usage policies are typically needed to tie the system into a manageable manner. Such allocation and usage policies include storage virtualization, cross volume and intra-volume storage, dependencies upon applications and users, and possible temporal dependencies as well. Using these techniques and criteria, among others, storage policies of entire entities can be managed, albeit they presently typically require modification of the data servers or the data storage devices, as well as possible intermediary software running on one of the ends of the transaction, or possibly both ends.

One crucial piece to running a large storage area network (SAN) is software that administers and controls all devices on the network. While a SAN configuration inherently makes management easier than in the case of network area storage systems (NAS), most companies will require a customized application to manage their SAN.

In a relatively small SAN implementation, customized software can be written to ensure communication among all devices. But as SAN systems grow, and as more vendors enter this space, simply writing management software may not be sufficient. Standard ways for components from different vendors to interact within the context of a SAN are not present, and as such, each storage server or storage device needs stand alone software implemented on the storage system to operate at an atomic level. Additionally, high level functions such as volume management, virtualization, and/or mirroring may need an extra layer of software to allow the storage systems to interact with one another in a cohesive manner.

Vendors in the storage, and specifically the SAN, market have realized this shortcoming. Through vendor-neutral organizations and traditional standards bodies, these issues are being raised and dealt with.

SAN systems typically require more thought and planning than simply adding one storage device to one server. However, as companies wrestle with reams and reams of information on their networks, this high-speed alternative should make operating the information age easier.

These SAN systems (and other types of large-scale storage solutions) can be used to perform several high level storage functions. However, the many typical solutions to large-scale storage systems are problematic due to their architectures.

A first type of solution to high level storage functionality can take a storage-centric approach. In this model, a coupling directly interconnects two disks: the primary volume (the disk being duplicated) and the duplicate disk. The software that controls duplication or mirroring resides within either one or on both of the two storage units. When a processor writes data to the primary volume, the storage unit writes or mirrors the data to the duplicate disk.

A second type of solution to high level storage functionality can take a server-centric approach. In the server-centric approach, both disks connect directly to a processor or server, which issues the disk write to that storage unit. In a dual write server-centric approach, both disks connect to the same processor, which issues multiple disk write commands one to each storage unit. In that case, the software that controls the mirroring operation resides on the processor, which controls the write operations to both disks.

Each of the engineering approaches can be used to implement high level storage functions that benefit the operation of a large scale data flow. The high level storage functions implemented by these approaches typically include storage virtualization and mirroring functions.

Storage virtualization is an effort to abstract the function of data storage from the procedures and physical process by which the data is actually stored. A user no longer needs to know how storage devices are configured, where they are or what their capacity is.

For example, it could appear to a user that there is a 1 terabyte (TB) disk attached to his computer where data is being stored. In fact, that disk could be elsewhere on the network, could be composed of multiple distributed disks, or could even be part of a complicated system including cache, magnetic and optical disks and tapes. It doesn't matter how data is actually being stored. As far as the user sees, there is just a simple, if very large, disk.

From a user's perspective, the storage pool is a reservoir from which he may request any amount of disk space, up to some specified maximum. The goal of the intervening software and hardware layers is to manage the disjointed disk space so it looks and behaves like a single attached disk. However, due to the fragmented nature of the area, with products coming from numerous vendors, the interoperability of systems as virtualization engines working in harmony is problematic.

Next, mirroring is a way in which data may be split into differing streams and stored independently in an almost concurrent (if not concurrent) manner, However, typical solutions have been implemented that are somewhat unscalable and require custom and specific software that intrudes either on the server or on the storage device. Typically, these software systems reside within either the source storage server or the storage device.

However, due to the specific nature of the systems, many typical solutions use of software presents several obstacles. First, the systems that operate on the SAN typically perform all the functionality associated with the storage functions. Many vendors of storage management devices and/or software put the functionality at this “head point”. Thus, in addition to servicing the normal storage functions associated with normal operation, the system is slowed by the third party management software running at another layer.

Second, the typical solutions are not usually scalable. A single storage server does not typically run the high level storage functions such as mirroring and virtualization for the data emanating from other servers. Thus, any storage management scheme must be implemented specially on each data storage server. This does not lend this solution to issues of scalability.

Third, the typical solutions are not usually efficient in using resources. If the software performing these functions is present, many times the software will fully assemble a file or data block from many datagrams. This full copy of the original data is then re-parsed into datagrams, and sent to the second storage device.

Thus, the implementation of high level storage functions is quite useful. But, many problems exist to successfully implement, and later manage, such large-scale storage systems.

### SUMMARY OF THE INVENTION

Aspects of the invention are found in a storage processor constructed on or within an integrated circuit (IC) chip. The storage processor has a plurality of ports operable to send and/or receive messages to/from storage devices. An output indication circuit is associated with each output port. The indication circuit indicates that data is ready to be transmitted to a storage device from the particular output port.

A crossover circuit is interposed between the ports. The crossover circuit has a memory that can store data. When data is received at a port, the storage processor can store the incoming data to the crossover circuit. A memory is also present on the chip. The memory holds data that relates incoming data to outgoing data. Thus, when data comes into the storage processor, the storage processor can determine a specific course of action for that data based upon the information stored in tin's memory.

The chip also has a plurality of processing sub-units coupled to the crossover switch. Based upon information in the memory, the processing sub units can access and change the data stored in the crossover switch. The sub-units and the ports themselves can relay information via the output indication circuits that specify that the data or the transformed data is ready to be sent from the particular port associated with the output indication circuit.

In response to the information on the output indication circuit, a port can then send the data or the transformed data from the crossover switch to a particular storage device. The data in the memory is used to specify the particular device or devices to which the data is sent.

### DESCRIPTION OF THE DRAWINGS

The accompanying drawings, which are incorporated into and constitute a part of this specification, illustrate one or more embodiments of the invention. Together with the explanation of the invention, they serve to detail and explain implementations and principles of the invention.

In the drawings:

FIG. 1 is a block diagram of an exemplary storage processor in accordance with the invention.

FIG. 2 is a schematic block diagram of an exemplary embodiment of a storage processor in accordance with the invention.

FIG. 3 is a schematic block diagram of an exemplary embodiment of a storage processor in accordance with the invention.

FIG. 4 is a schematic block diagram of an exemplary storage processor in accordance with the invention.

FIG. 5 is a schematic block diagram of a processing subsystem having multiple sub-units operating in an exemplary storage processor in accordance with the invention.

FIG. 6 is a schematic block diagram detailing the operation of a processing subsystem scheduler in a storage processor in accordance with the invention.

FIG. 7 is a block diagram detailing an inclusion of a support processor working in conjunction with the processing sub-units.

FIG. 8 is a schematic block diagram detailing an inclusion of a memory controller working in conjunction with the processing sub-units.

FIGS. 9a-d are logical block diagrams detailing the ability of a context switching processing sub-unit of an exemplary storage processor in accordance with the invention.

FIG. 10 is a schematic block diagram of an alternative context switching processing sub-unit of an exemplary storage processor in accordance with the invention.

FIG. 11 is a schematic block diagram of a possible crossover switch as it might exist within an exemplary storage processor in accordance with the invention.

FIG. 12 is a schematic block diagram of a possible memory management scheme within a crossover switch as it might exist within an exemplary storage processor in accordance with the invention.

FIGS. 13a-d are schematic block diagrams of a possible memory management scheme within a crossover switch as it might exist within an exemplary storage processor in accordance with the invention.

FIGS. 14a-c are data diagrams detailing a data structure and method that could be used in the mapping of multiple contexts to a series of data blocks.

FIG. 15 is data diagram detailing the logical view of an operation of a port output control in a storage processor in accordance with the invention.

FIG. 16 is a data diagram detailing an alternative logical view of an operation of an output port control in a storage processor in accordance with the invention.

FIGS. 17a-b are data diagrams detailing how the data operations may be implemented within a crossover switch in accordance with the invention.

FIGS. 18a-b are data diagrams detailing alternative schemes of how the data operations may be implemented within a crossover switch in accordance with the invention.

FIGS. 19a-c are logical block diagrams detailing a data coherency scheme that could be used with a storage processor in accordance with the invention.

FIG. 20 is a logical block diagram detailing one such data integrity scheme associated with a storage processor in accordance with the invention.

FIGS. 21a-d are schematic block diagrams detailing a memory structure that could be used in the transfer of data to an output port in a storage processor in accordance with the invention.

FIGS. 22a-d are schematic block diagrams of a possible memory management scheme within a crossover switch as it might exist within an exemplary storage processor in accordance with the invention.

FIG. 23 is a logical block diagram detailing an exemplary bandwidth allocation scheme that could be used in conjunction with a storage processor in accordance with the invention.

FIG. 24 is a timing diagram detailing how an exemplary storage processor in accordance with the invention can reorder datagrams.

### DETAILED DESCRIPTION

Embodiments of the present invention are described herein in the context of an apparatus of and methods associated with a hardware-based storage processor. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-, engineering-, and/or business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of integrated circuits. In addition, those of ordinary skill in the art will recognize that devices of a more general purpose nature, such as hardwired devices, field programmable gate arrays (FPGAs), application specific integrated circuits (ASICs), or the like, may also be used without departing from the scope and spirit of the inventive concepts disclosed herein.

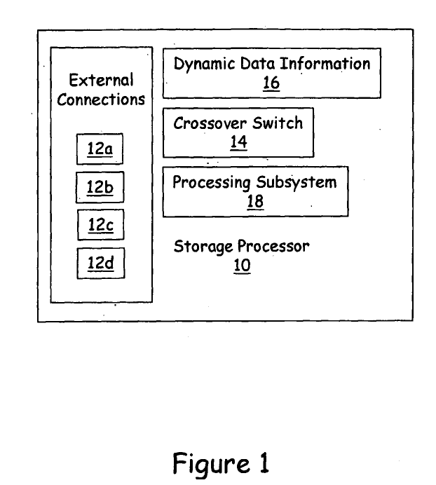

FIG. 1 is a block diagram of an exemplary storage processor in accordance with the invention. A storage processor 10 has one or more external network connections 12a-d, respectively. Although four connections are shown, any number may be implemented. The network connections 12a-d couple the storage processor 10 to one or more storage devices, such as storage servers that implement a SAN, various information generating devices, various target storage media, or other such storage related devices.

Data to be stored or commands related to storage devices can come in through any connection 12a-d, and correspondingly, retrieved data can come into the storage processor 10 through any of the connections 12a-d. Such data storage can be of the form of datagrams, having internal datagrams. The datagrams are typically a datagram contained within a transport level encapsulation. These datagrams can be either command or data datagrams. The command and data datagrams usually adhere to some storage network protocol. Such protocols may include Network Data Management Protocol (NDMP) and Internet Storage Name Service (iSNS) at the high end. Also, the transport may involve a Small-Computer-Systems Interface (SCSI), an Enterprise System Connection (ESCON), or Fibre Channel commands directing specific device level storage requests. Such protocols are exemplary in nature, and one skilled in the art will realize that other protocols could be utilized. It is also possible that there may be multiple layers of datagrams that may have to be parsed through to make a processing or a routing decision in the storage processor.

The datagrams are received by the storage processor 10 and analyzed. Information from both within the datagrams and from within the encapsulated datagram are analyzed. Based on the analysis, the datagrams can then be forwarded to a crossover switch 14. The crossover switch 14 uses a dynamic storage information 16 to process and send the storage command or data to another device in a specific manner. This dynamic storage information 16 may be present within the storage processor 10, or may be accessed from a neighboring device such as a writable memory or storage medium. For example, the dynamic data information 16 may contain data that directs the crossover switch to match the input and output characteristics of the devices even though the input and the output differ in their data transfer characteristics. The dynamic storage information 16 may also contain information that directs the storage processor 10 to operate in such a way that a specific data storage datagram will be sent to a one or more other various targets at other various speeds.

The incoming datagram is received at a port 12, and information from within the datagram is read by the storage processor 10 (i.e. a “deep read”). Based upon this information, possibly from all the layers of datagrams, the storage processor 10 determines a course of action for datagram, such as duplication, reformatting, security access, or redirection. Such actions can be based upon such items as the source, the target, being identified as coming from a specific process, coming from a specific user or group, or other such information.

In addition to determining a proper course of action, such a deep read can be used to distinguish between command datagrams and data datagrams. In some protocols, there may be other datagrams aside from data datagrams and command datagrams, and the datagram read can distinguish these as well. The storage processor can then distinguish between command datagrams and storage datagrams on the communication level. This information allows the storage processor to dynamically instantiate actions based upon an analysis of the command datagrams, or send such information to remote monitoring applications. Accordingly a remote monitoring application can be envisioned that does not require any network overhead, since the command datagram information can be copied within the storage processor and relayed directly to the monitoring application. In this manner, the monitoring can occur with no additional processing overhead to the storage devices or to the network.

In one course of action, the storage processor 10 may have dynamic storage information 16 that dictates the datagram arriving on the particular port should be simply rerouted straight through to another port. In this case, the storage processor 10 would send the incoming datagram to the appropriate port for output, keeping the internal information such as destination and source indicators the same. Or, the storage processor could direct that the datagram be sent to the crossover switch 14, (hen redirected to the appropriate output port. The appropriate output port may be determined by the mapping functions of the dynamic data information.

In another case, the dynamic storage information 16 may indicate to the storage processor 10 that the datagram needs to be routed to a differing destination than the one indicated in the arriving datagram. In this case, the storage processor 10 would store the data in a crossover switch 14, and direct that a processing subsystem 18 process the outgoing datagram accordingly. (One should note that in the context of the storage processor, “data” may include data stream datagrams, command stream datagrams, or other various types used by other types of protocols.) In this case, the processing subsystem 18 might resize the outgoing datagram, or may perform other types of control mechanisms on the datagram. Upon performing the specific actions on the data, the storage processor 10 would then send the newly built datagram to the appropriate port.

In another case, the dynamic storage information 16 may indicate to the storage processor 10 that the datagram needs to be duplicated and routed to an additional source. Of course, storage processor 10 may indicate that in addition to the new copy, the original may be sent to the original destination as indicated in the datagram, or it may be sent to a differing destination. Again, the storage processor 10 could then store the data in a crossover switch 14, and direct that the processing subsystem 18 process the outgoing datagram accordingly, for the more than one instance of the datagram. Again, the processing subsystem 18 might resize the either of the outgoing datagrams, or may perform other types of control mechanisms on the outgoing datagrams. Upon performing the specific actions on the outgoing data, the storage processor 10 would then send the newly built datagrams to the appropriate port for transmittal.

Accordingly, the dynamic storage information 16 could contain such information that would make the storage processor 10 determine whether to pass a datagram through without processing, whether to redirect a datagram, or whether to create a copy datagram to aid with such functions as mirroring or replication. Additionally, the dynamic storage information 16 may contain specific information that allows the storage processor 10 to define and maintain a virtualization of a storage space.

In one embodiment, the information may be in the form of tables stored on the integrated circuit. For example, in this embodiment the dynamic storage information 16 can contain information on ports and storage addresses, or possibly even ranges of storage addresses. Thus, the storage processor 10 could make a determination on the actions to take based upon the port of arrival and the destination. In some embodiments, the storage addresses could be of the form of a machine, a subsystem on a device, or a particular location within a particular device.

For example, assume that a datagram arrived on port 12a, and its destination is given as Machine 1 (in the appropriate storage address space, which could signify a request to a device, or request to a specific subsystem or area of the device, or portions of a virtual device.) The storage processor 10 may then identify that particular transaction (by source, destination, or other criteria) by matching those parameters with data in the dynamic storage information 16. Accordingly, transactions destined for Machine 1 may be mirrored. Or, they may be redirected to other attached devices, thus allowing Machine 1 to be a virtualization of the storage space. Or, they may be reformatted to be transmitted more efficiently to Machine 1. Or, they could be reformatted into a form that Machine 1 understands, thus allowing the storage processor 10 to become a self-defined “bridge” between otherwise incompatible storage mechanisms. Or, machine 1 may be a virtual machine, whereby the mapping might dictate where in the real storage space items might be placed.

Further, the storage processor could be used to enforce security policies. In this case, the dynamic data information would contain checks of incoming datagrams with directions where they might go, or with checks on which sources might have access to such requested storage. When a mismatch occurs, the storage processor 10 might be used to signal than there was an invalid storage request processed.

In addition to the functionality of processing data, the command stream of a storage device or client may also be altered within the operation of the storage processor 10. The storage processor 10 can either channel responses to requests or other command stream messages to the target through the remapping. Or, the storage processor 10 can act as a trusted intermediary, responding to the original request with its own inherent message creation capabilities. In the latter context, this enhances the functionality of the storage processor 10 in terms of defining a virtual storage system. In this manner, the storage processor 10 may act as a proxy node representing the entire storage space: virtual and real. For example, such additional functions as striping the data across target media, directing the storage data to specific storage groups, devices, subsystems of devices, sectors, or cylinders of a target storage device can all be realized through the datagram and datagram level operations performed by the storage processor 10.

Even in the absence of such virtualization or other high level storage functionalities, the storage processor 10 can act in a manner that optimizes the throughput of the system. The storage processor 10 can monitor the incoming traffic destined for a single data device, and alter the outputs so as not to waste line bandwidth. Further, time based multiplexing through the same port can be accomplished.

The processing subsystem 18 may further deconstruct the datagrams and/or datagrams and reconstruct them according to specific criteria. For example, the processing subsystem 18 may change the datagram data size, may change the addresses of the datagrams, may change the data format, and/or may implement storage specific criteria for the datagram.

Thus, the storage processor 10 is a dedicated hardware system that receives storage datagrams, and implements the elemental functions necessary for high level storage services such as virtualization and proxy services. In this manner, an external storage server, which would otherwise be handicapped with extraneous vendor specific or custom software running to direct these high level storage functions, may be implemented in a cost free and optimal manner. Accordingly, this frees more of the storage server resources for its core functional purpose(s). The storage processor 10 can implement storage virtualization on a datagram level basis through the use of internal defined tables.

Further, this frees the storage server of having to perform high level services such as virtualization and mirroring on a “file” basis. The storage processor 10 intercepts the data on a datagram basis, and performs operations on the datagrams and datagrams that not only optimize the storage process, but also allows high level storage functions to be processed at a most basic level—the communications level.

Accordingly, the onus typically placed on the storage server implementing the high level storage strategies is reduced, as well as onus that can be placed on the corresponding storage-centric system as well. In this manner redirection, mirroring, and virtualization may be implemented external to the storage server and/or storage device.

Further, the architecture lends itself to scalability. When the need arises for new storage inputs or storage targets, the new inputs and/or targets may simply be defined internally to the storage processor 10 with no modification to any the new or existing servers, or any of the new or existing storage devices.

When the flow is such that a single storage processor 10 cannot operate on the new flows, another storage processor 10 may simply be placed in parallel with the same operating dynamic storage information. In this manner, no alterations need be placed either on the storage servers or on the storage devices to handle other new devices and other new flow. Thus, new levels of throughput may be reached without massive reworking of the base storage servers and/or storage devices, freeing both time of a technical staff and the resources expended in reworking new servers to conform to already existing storage policies.

The crossover switch 14 may be employed to direct the data one of the connection ports 12a-d to the processing subsystem 18, and vice versa. Or, the crossover switch 14 may also be employed to direct the data from one of the connection ports 12a-d to another of the connection ports 12a-d. Similarly, the crossover switch 14b may also be used to redirect a datagram from the processing subsystem 18b back to itself This can be useful if the processing subsystem 18 is composed of several subsystems or if the storage processor 10 has a need to preempt an ongoing process in favor of one having a higher priority.

In the context of FIG. 1, the traditional paradigm of employing a general processor in conjunction with a computing operating system has been subsumed. To wit, the general processor typically has to make extraneous calls to external memories to access certain items, such as data, instructions, or access to the external data storage devices themselves. Further, the general processor must traverse the operating system hierarchies and/or various user spaces and/or kernel spaces to implement its functionality. For example, in the case of the general processor, a datagram is typically received at a communication port, moved to a portion of general memory visible to processor, the general processor is typically interrupted to process the datagram, and this typically must include accesses by the general processor to the operating system and any user-defined spaces existing thereon. In the case of the present invention, the path and resources consumed are drastically reduced, as well as the data in the datagram being accessed and processed at wire-speed.

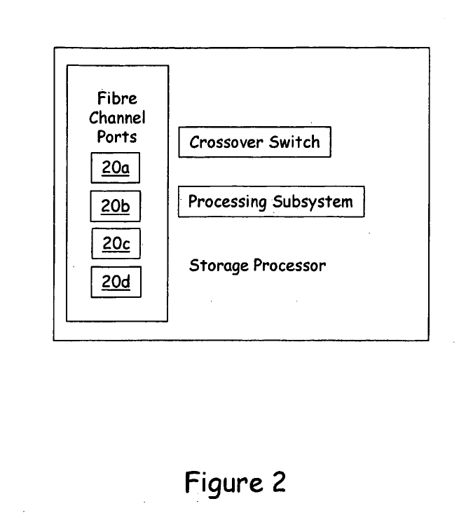

FIG. 2 is a schematic block diagram of an exemplary embodiment of a storage processor in accordance with the invention. In this embodiment, the connection ports 20a-d are depicted as Fibre Channel ports, as is common to many SAN systems. However, they might be any of a number of communication ports operable to send electronic data to and/or from storage devices.

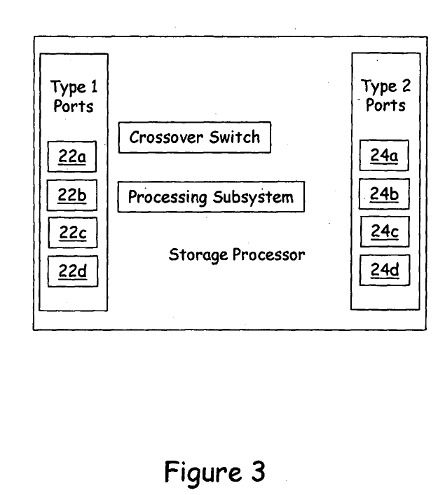

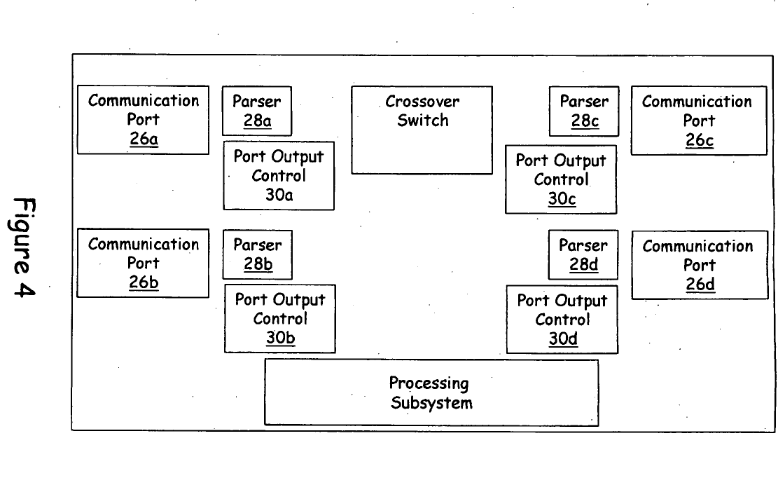

FIG. 3 is a schematic block diagram of an exemplary embodiment of a storage processor in accordance with the invention. In this embodiment, the connection ports 22a-d and the connection ports 24a-d are shown as two differing protocol ports. For example, the first format could be Fibre Channel ports, and the second format could be wired Ethernet connections. Many differing formats, both in single use and in mixed use, are possible, and one skilled in the art will realize that these many different protocols may be used, both in single use and in many differing mixes.

In this case, the storage processor 10 can convert the datagrams between the differing formats. This can be accomplished with the processing subsystem 18. Additionally, specialized purpose logic may be employed to work in conjunction with the processing subsystem (and possibly specific sub-units of the processing subsystem as described supra.) This specialized purpose logic may be employed to perform tasks that are common an/or expected with the incoming data. Such functions could include assigning flow identifications (flow ID's), pre-fetching contexts (explained supra), among others. Again, this can be aided with the help of dynamic data information (not shown in this FIG.). Accordingly, many differing storage devices may be serviced and bridged without any extraneous or intervening software.

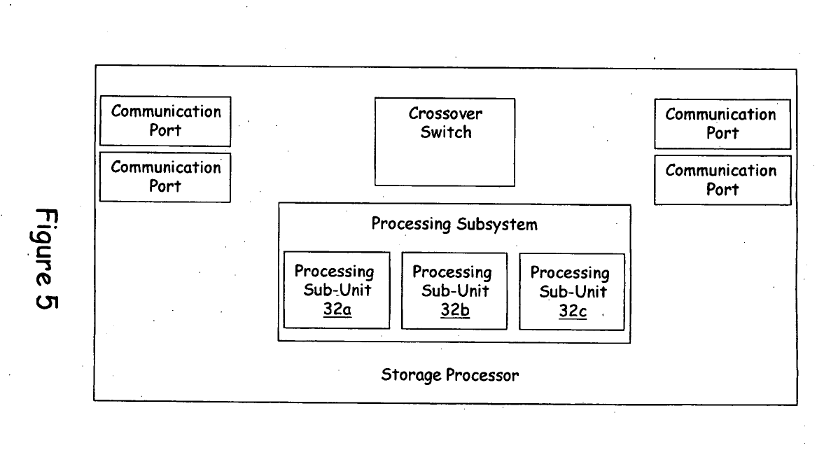

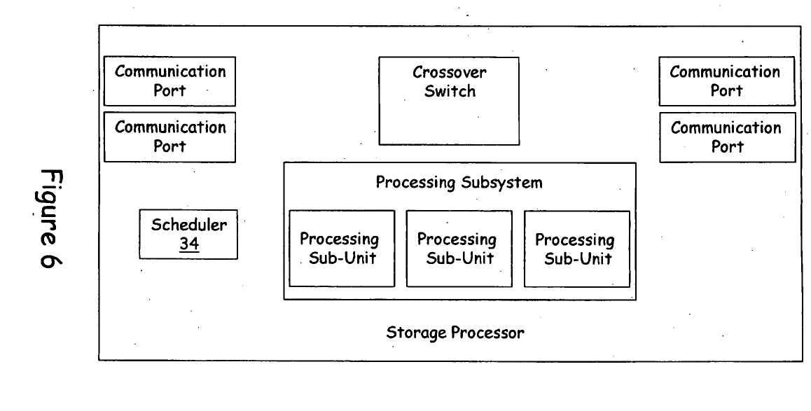

FIG. 4 is a schematic block diagram of an exemplary storage processor in accordance with the invention. Input ports 22a-b are depicted, and can be coupled to storage request generators such as storage devices and/or clients (not shown). One or more parsers 26a-b may then be used to analyze various values within the incoming datagram and the datagrams in order to be operate upon the data properly. Such values within the datagrams and/or encapsulated datagrams may include source, destination, user, application, Logical Unit Number (LUN). Other factors can be considered and acted upon, such as time and system factors, like loading and throughput.

The parser 28 then may cause the datagram (rebuilt or not) to be sent to the crossover switch. The crossover switch can then store the data prior to any other action being performed on it. In one alternative embodiment, the parser 28 can initiate a mechanism for outputting the data to the appropriate output port, based upon the data in the dynamic data information (not shown in this Figure.) In some exemplary cases when the data is “passed through” unaltered, the parser could cause the data to be : a) written directly to an output queue associated with the proper output port; b) written to the crossover switch with an indication to an output port where the data can be found; or c) written to the crossover switch and allowing mechanisms internal to the crossover switch to schedule the data for output in the appropriate port. Of course, such action might be undertaken with another mechanism not associated with the parser. Such mechanisms could also be associated with the crossover switch, the processing subsystem, or some independent system within the storage processor. The parser can also perform datagram layer separation and place them in the crossover circuit (for example, header payload separation). The parser could also perform protocol specific datagram data integrity checking. The integrity of the various layers of the datagrams may be checked, in addition to overall integrity checks for the entire incoming datagram. Such examples of integrity checks include, but as an example and not limited by, such operations as a cyclic redundancy check (CRC) for the layer(s) of the datagram, and/or the entire datagram. Such an integrity check could also generate data integrity values on one or more of datagram layers and place them in the crossover circuit.

In cases where the data is to be acted upon in some manner, the parser can also initiate related actions. In this case, the parser could cause the data to be: a) written directly to an output queue associated with proper transformation process (usually by the processing subsystem 18); b) written to the crossover switch with an indication to the appropriate transforming device to act upon; or c) written to the crossover switch and allowing mechanisms internal to the crossover switch to schedule the data (various layers of datagrams or the entire datagram) for an appropriate intermediate action. Of course, such action might be undertaken with another mechanism not associated with the parser. Again, such mechanisms could also be associated with the crossover switch, the processing subsystem, or some independent system within the storage processor.

One such action that the support processor might undertake on the data might include operating on the data by the processing subsystem 18. The processing subsystem 18 may reformat the datagram into requests for the particular storage media, may reformat the datagram into larger or smaller datagrams for transmittal to the particular storage media, and/or may send the data datagram or some reformation of the data datagram to more than one data storage units. Such actions by the processing subsystem are undertaken as a result of the values extracted from the incoming message and the values within the dynamic data information.

Another action may include the notification of another port that the data is present and ready to be transmitted to a storage device or client from the crossover switch. The particular port that it is transmitted by may also be derived from the values extracted from the incoming message and the values within the dynamic data information. This can take place with or without the processing action noted above.

The processing subsystem 18 can be port addressable. Accordingly, an incoming message might contain instructions or new operating parameters for the processing subsystem 18.

Still another action may be a duplication of the data in the crossover switch, indicating that a reformatting and a duplication is needed. Or, the data may be placed in the crossover switch with an indicia of how many times the data should be relayed out from the storage processor. This might occur in the case of replication and/or mirroring.

Assuming that the incoming message is targeted for a storage device or client, the storage processor can then cause the datagram to be optionally rebuilt or not, depending upon whether virtualization is being employed or whether other functions are enabled that would cause extra formatting of the datagram while passing it to the ultimate destination.

In the case where no reformation is needed, the parser 28 can then initiate a mechanism such that a port control 30 associated with the target output port 26c is made aware of the stored data destined for transmittal from the target output port 26c. In this case, the signal on the port control 30 can cause the data in the crossover switch to be read and sent out of the appropriate port and destined for the appropriate destination.

In the case where the data needs reformatting or the storage processing system decides that the processing subsystem 18 needs to operate on the data (i.e. for new headers, virtualization purposes, mirroring purposes, to name a few), the parser 28 can then initiate a mechanism that eventually informs the processing subsystem 18 that the data is in the crossover switch. Further, this mechanism could enable an appropriate function or transformation to be implemented on the data.

When the processing subsystem 18 finishes its operations associated with the data, the parser 28 can then initiate a mechanism that eventually informs the port control 30 that the data in the crossover switch (or its transformation) is ready for delivery to the ultimate target. When this happens, like that mentioned above, the data should be sent to the appropriate destination from the appropriate port.

Of course, the port 26c may operate either in an input mode, in an output mode, or both (as may any of the other ports). In this case, the port output control 30c could interact with a parser 28c associated with the port 26c to coordinate the inflow and outflow of data through the particular port.

In one case, the port control 30c may read a portion of memory of the crossover switch. Such a portion may be used by the device making the data ready to indicate to the port output control 30c that data is ready. This could be in the form of a queue or a linked list within the crossover switch memory. Or, the output control may have its own dedicated memory in which to implement the indication of output tasks.

In one embodiment, a virtual output list is maintained in the crossover switch for each port. In one embodiment, this virtual list is maintained as a linked list of data heads, with each data head having a pointer to the data to be output. When new datagrams are input into the crossover switch, the head portions for the newly incoming datagrams can be created and linked to the appropriate tail of each virtual output queue associated with the appropriate output port(s) for that particular datagram.

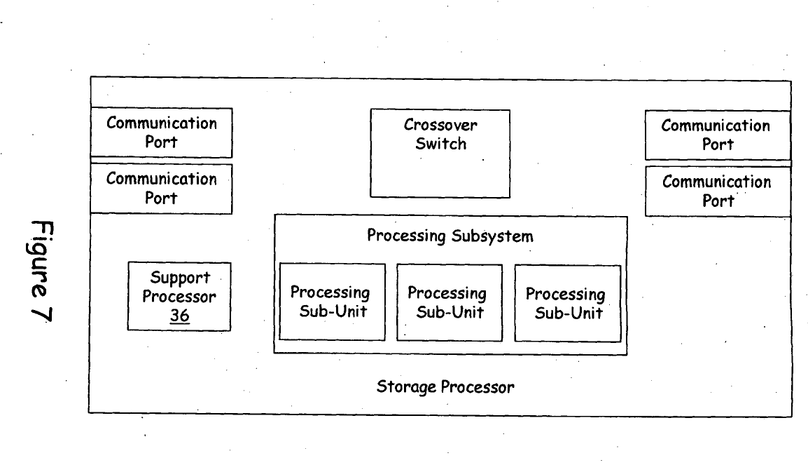

FIG. 5 is a schematic block diagram of a processing subsystem having multiple sub-units operating in an exemplary storage processor in accordance with the invention. In this exemplary embodiment, a processing subsystem 18a is comprised of a plurality of processing sub-units 32a-c. In this case, the incoming datagrams that are communicated into the crossover switch are loaded among the several processing sub-units. Accordingly, this allows a storage processor 10c to operate in an efficient maimer. In this case, the storage processor 10c can be accepting, parsing, and placing the datagram contents into the crossover switch while work is being done on datagrams already resident in the storage processor 10c.

The processing sub-units 32a-c may be individually tasked with specific tasks, such as, for example, formatting datagrams for one particular storage device. As another example, one or more of the processing sub-units 32a-c might be tasked with handling certain events, such as storage device error handling. In another example, one or more of the processing sub-units may be tasked with command stream tasks as opposed to data stream tasks.

Further, the sub-units may be each individually port-addressable, or related sub-units may be port addressable as a group. If the sub-units are port addressable, specific messages for each sub-unit or sub-units may be targeted to the storage processor through a communication port. It is also possible for on or more of the processing sub-units to have one or more communication ports that are dedicated to the processing unit so that information or data need not go through the crossover switch. Examples of such ports can include an RS-232 Serial port, a 10/100 Ethernet media access control layer (MAC) port, optical or infrared systems, or wireless interfaces, among others. One skilled in the art will realize that many differing communication ports and methods are possible, and this list should be as read as exemplary of those, hi an exemplary embodiment, the processors can be ARC processors. These are reduced instruction set computing devices (RISC), which can operate at 300 MHz. Running with 10 ARC processors, a data rate of 3.5 million datagrams per second can be achieved. The relationship between data rate and processors is approximately linear, so running with 2 ARC processors can result in a data rate of approximately 700,000 datagrams per second.

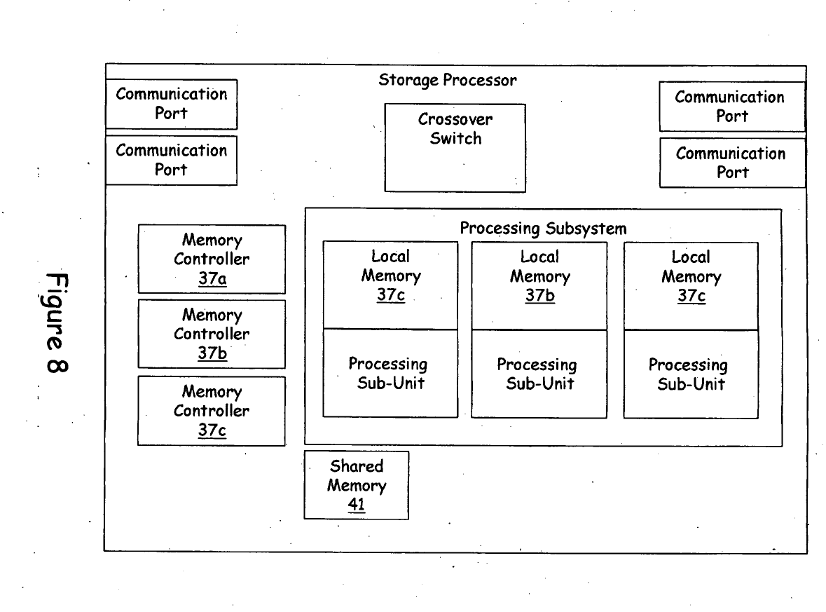

FIG. 6 is a schematic block diagram detailing the operation of a processing subsystem scheduler in a storage processor in accordance with the invention. In this case, the storage processor has a plurality of processing sub-units, as described before. When a request is made for the use of the processing subsystem, a scheduler 34 can be used to make a determination as to which processing sub-unit(s) should perform the task. The determination scheme can be dynamic and set by an operator. Or, it can be changed by operational parameters. Such schemes may include a round-robin or by the numbers of tasks being performed by the processing sub-units, as examples, among others that one skilled in the art will readily know. Further, the scheduling of the sub-units may be differentiated by a combination of parameter-based and task-based operations. In this case some processing sub-units can be allocated in a standard fashion (such as round-robin, weight loading, among others), while other processing sub-units handle specific types of tasks, datagrams, or other operational aspects (e.g. target, source, among many others.)

One skilled in the art will realize that the number of processing sub-units depicted in the Figures can be chosen from a wide variety of values. This disclosure should be read as considering any single processing system or any number of processing sub-units working in conjunction with one another. Additionally, any number of operational parameters can be used in conjunction with the allocation of the work load among them, and others besides those listed above are possible and implementable.

FIG. 7 is a block diagram detailing an inclusion of a support processor working in conjunction with the processing sub-units. In this case, a support processor 36 can monitor or alter the operation of the other processing sub-units. The support processor 36 may be able to access the instructions of the other processing sub-units, or access the processing sub-units themselves. In this manner, the support processor 36 can indicate to another processing sub-unit to stop operating and shutdown its work, or can alter its functionality. This could occur after the target processing sub-unit processes its remaining items, but it could happen during such operations. Such a support processor can be of the same type as the other processing sub-units, or it can differ in architecture and/or operating speed from the processing sub-units.

While the processing sub-unit is halted, the support processor 36 can rewrite the instructions of the particular processing sub-unit. It might also be able to rewrite the dynamic data information, thus altering the high level storage functionality of the storage processor. In this manner, the storage processor can dynamically rearrange the operational components of the system.

For example, the support processor 36 might halt the operation of one of the processing sub-units operating as a generic datagram writing processing sub-unit, and rewrite its instructions to do nothing but handle exceptions. In this case, the support processor 36 might also at the same time change the operational parameters of a processing scheduler to redirect all exceptions to the newly redefined processing sub-unit. Then, the support processor 36 can then restart the operation of the processing sub-unit(s) in question and possibly restart to the processing scheduler. Or, the support processor 36 can be made aware of an operational parameter change at the operator level. In this case, it could rewrite the dynamic data information in order to implement different high level storage functions for the differently defined datagrams and/or datagrams. Thus, the support processor 36 can dynamically shift or alter the individual operating processing sub-units within the storage processor, or change the operating mode of the storage processor relative to the communication level storage functions themselves.

The support processor 36 can be accessed directly from an external source. Or, it can be accessed by a definition of it as a port within the context of the parser/crossover switch operational scheme.

FIG. 8 is a block diagram detailing an inclusion of a memory controller working in conjunction with the processing sub-units. One or more memory controllers 37a-c are present on the IC. Memory for any localized buffers 39a-c for the processing sub-units, or shared memory 41 for the processing sub-units can be managed by the memory controller 37. This memory can be such as, for example, dynamic random access memory (DRAM), static random access memory (SRAM), content addressable memory (CAM), or flash memory. One skilled in the art will realize that this list of semiconductor memories is exemplary, and many others can be utilized.

The memory controllers can be accessible to the processing sub-units to store and retrieve processor information or datagrams. The memory controllers also have the ability to interface to the crossover switch to transfer data from the memory to the crossover switch.

In one embodiment of the memory controller, the memory controller has several agent interfaces to which agents that require read/write access to the memory—for example, a processing sub-unit—can post such requests. A tagging mechanism is provided by which requesting agents can tag their requests, in addition to the address interface, a data interface and a control interface. These requests are tagged by the agent. The tag identifies the requesting agent and the request# of that agent. During read operations, the requests issued by one agent can be re-ordered by the memory controller for providing maximum memory bandwidth. The tag is returned by the memory controller along with the read data. The requesting agent uses this tag to associate the data with a request.

In another embodiment of the memory controller, the memory controller has a memory crossover switch (mcs) coupled with the agent interface and the memory controller state machine. Each memory controller state machine controls a specific instance of external memory, for example a DDR SDRAM. There can be several such memory controller state machines coupled to the mcs. The mcs maps the request from the agent interface to the appropriate memory controller based on the programmable, predetermined address mapping and presents the requests to the mcs.

In one embodiment of the memory controller, the memory controller state machine can choose the requests that is presented to it by the memory controller state machine. The decision of which request to choose is based on the characteristics of the memory, so that the maximum utilization of the memory data bus is achieved.

In one embodiment of the memory controller, the memory controller state machine can perform atomic operations based on the control received for a request. For example, the control that is received as a part of the request can specify, a read/modify-increment/write operation. In this case, the components of such a request might be—the address, read/modify-increment/write indication, increment value. For those skilled in the art, it is immediately evident that several such requests with different control attributes are possible.

In certain cases the processing sub-unit, or a specialized processing sub-unit can be dedicated as an agent to transfer data from the crossover switch or other processing sub-units to the memory. This specialized sub-unit may perform transforms, calculations, and/or data integrity checks to the data as it is being transferred from the crossover switch to the memory and vice-versa.

It is also possible for one or more of the processing sub-units to have one or more memory controllers dedicated to that processing unit whereby any data need not go through the crossover switch (for example—a Serial Flash.)

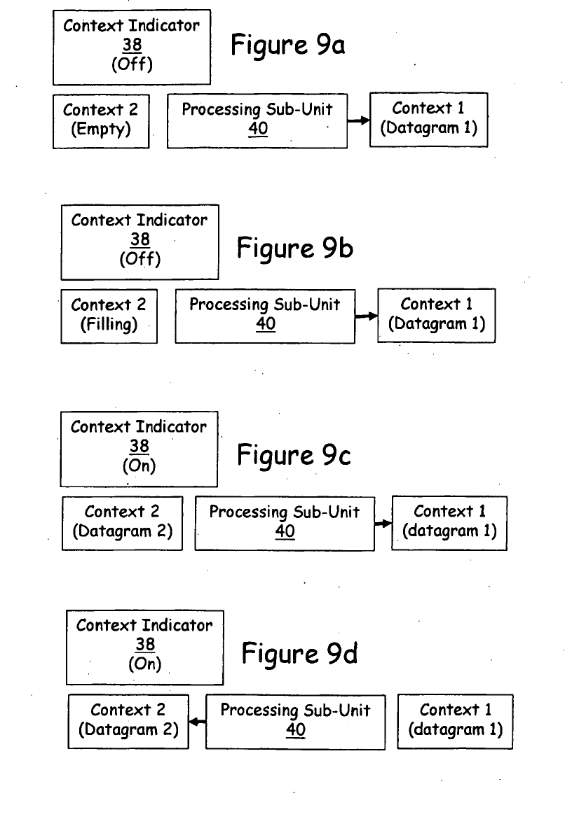

FIGS. 9a-d are logical block diagrams detailing the ability of a context switching processing sub-unit of an exemplary storage processor in accordance with the invention. In this embodiment, a processing sub-unit (or one of a number of processing sub-units) has a buffering scheme that aids in optimizing the workload of the processing sub-units.

In FIG. 9a, the processing sub-unit is working in a first context. In FIG. 9b, a buffer (either local to the processing sub-unit or within the crossover switch) is being filled with other data. The step depicted in FIG. 9b is optional, since such data might already be present, but is shown for clarity. Since a context indicator 38 does not indicate that the second context should be acted upon, the processing sub-unit continues to work on the first context.

In FIG. 9c, the second context is ready to be operated upon. Accordingly, the context indicator 38 signifies this state. Upon detecting this slate (FIG. 9d), the processing sub-unit shifts operation to the second context. In one aspect, the halted context one state may be saved, so that the processing sub-unit can resume the work on that context.

In a similar vein, a related system may be employed to ensure high efficiency in the operation of each processing sub-unit. Instead of the “interrupt” ability described above, the context indicator may be used to signal to the processing subsystem that a second context is ready for its operations at the conclusion of operating on the first context.

As an example, while the processing sub-unit 40 is operating upon a previous datagram, another datagram is may be made available for operations. The storage processor can then indicate to the processing sub-unit 40 that another datagram is available to be operated upon. The data may be filled in a memory local to the sub-unit, or data may exist within the crossover switch. Upon completion of the task at hand, the processing sub-unit 40 is made aware (through the use of a semaphore or other device) that another set of data is ready to be processed. Accordingly, the processing sub-unit 40 may be utilized with high efficiency.

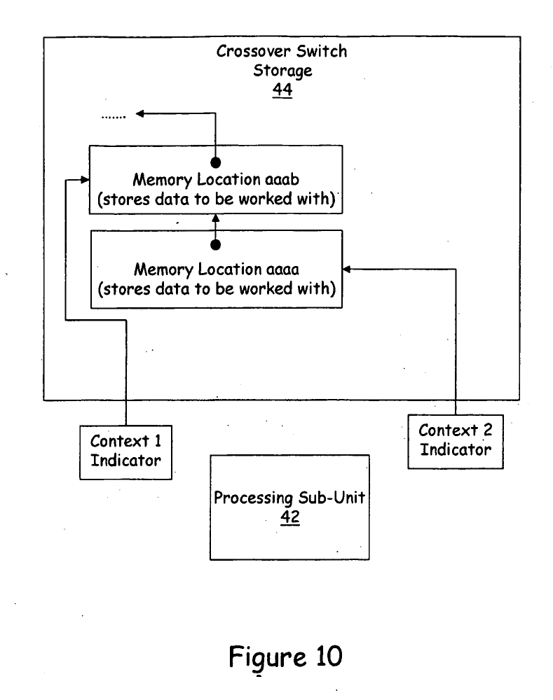

FIG. 10 is a schematic block diagram of an alternative context switching processing sub-unit of an exemplary, storage processor in accordance with the invention. In this embodiment, the linked list of memory sectors can be replaced by buffers local to the processing sub-unit. In this case, the indication to the processing sub-unit 42 might be in the form of a pointer into the crossover switch storage 44. This area of the crossover switch storage could contain a first block of the data, and a pointer to the next block of data. When the processing sub-unit 42 is finished operating on the first block of data, it uses the included pointer to traverse to the next block. This can be repeated until all the blocks have been processed.

When the last block has been processed, or the processing sub-unit 42 is interrupted, the processing sub-unit 42 can then context switch to the next block. In this case, this frees the particular processing sub-unit 42 from having to wait for data from any one particular source. Further, this allows any processing scheduler to distribute the load amongst the plurality of processing sub-units.

In FIG. 10, the processing sub-unit 42 is working on two differing contexts of the same incoming data. It should be noted that the contexts could refer to the differing actions for the same data, or for different data altogether. It should also be noted that the processing sub-unit may work from localized data (buffers local and accessible to the processing sub-unit) as well as storage in the crossover switch, as depicted.

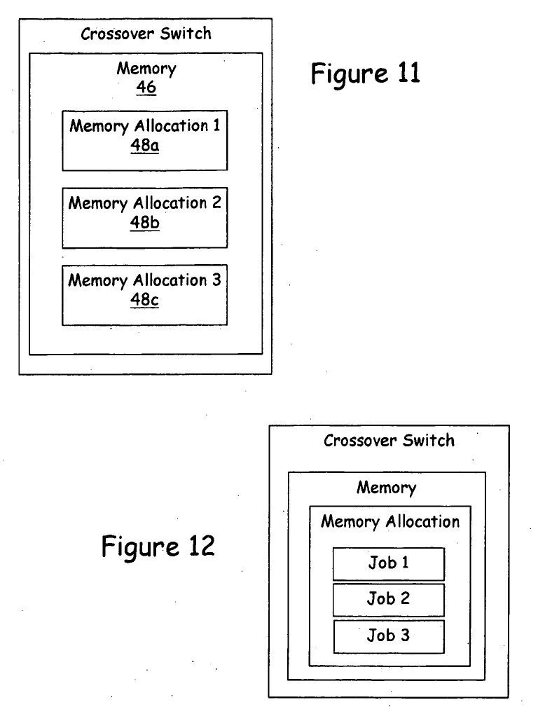

FIG. 11 is a schematic block diagram of a possible crossover switch as it might exist within an exemplary storage processor in accordance with the invention. A crossover switch can have a memory 48. As data comes into the crossover switch, it can be stored into memory locations 48a-c. The memory management module can partition the memory 46 into sections based on predetermined criteria, hi one example, any memory management module can assign the memory sections in a proportion. In another example, the memory management module can partition the memory space amongst processing sub-units (if more than one exists), either in direct proportion to their numbers or based on a weighted criteria.

Additionally, the memory management module could partition the memory partitions 48a-c based upon other criteria such as the source device, just to name one other example. Numerous other criteria could be used in the memory management determination.

FIG. 12 is a schematic block diagram of a possible memory management scheme within a crossover switch as it might exist within an exemplary storage processor in accordance with the invention. In this instance any memory management module could enforce “block-style” memory grants, whereby particular jobs, source machines, destination devices, or assigned processors could place the related incoming information.

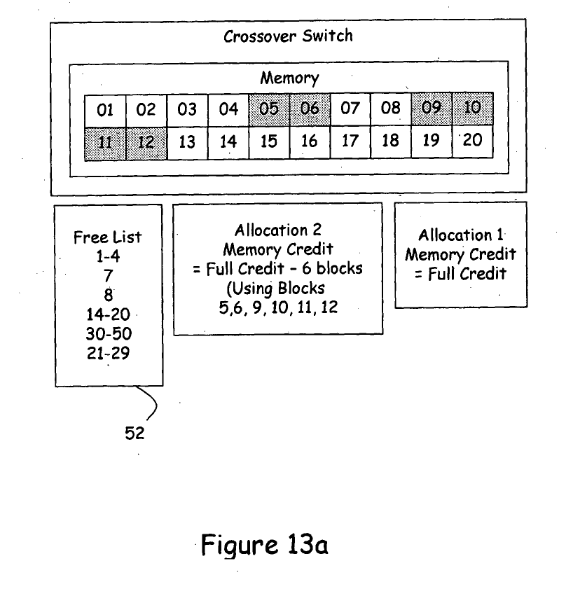

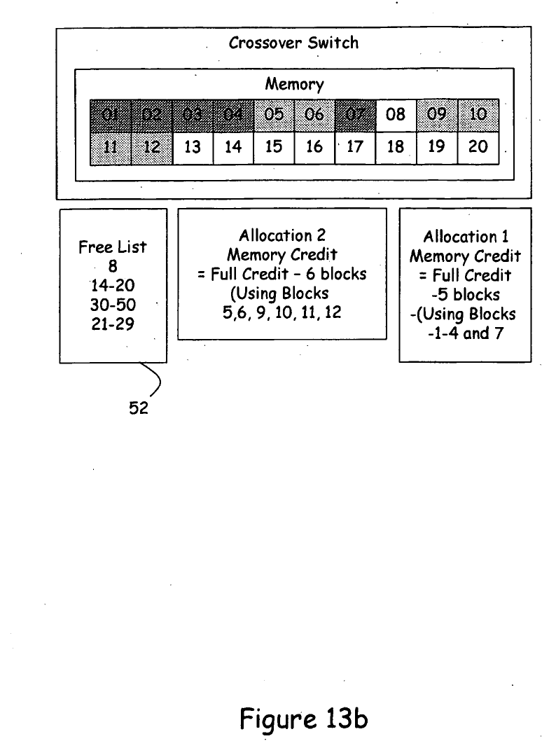

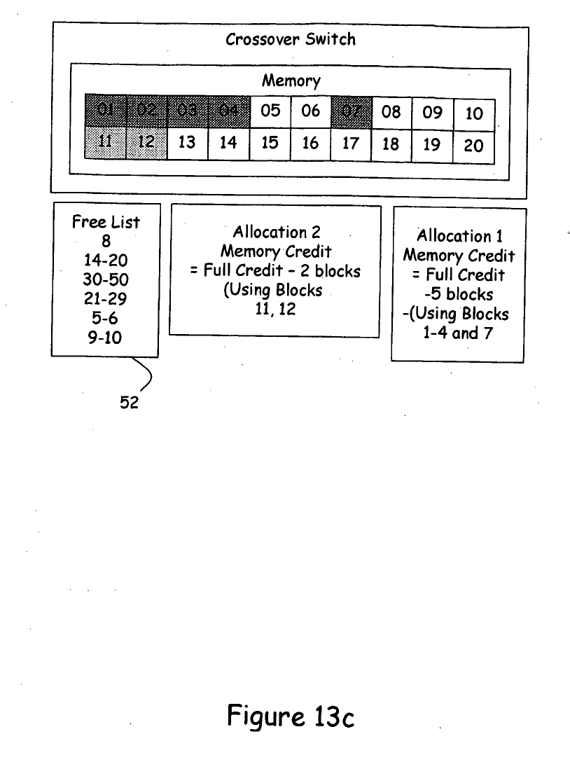

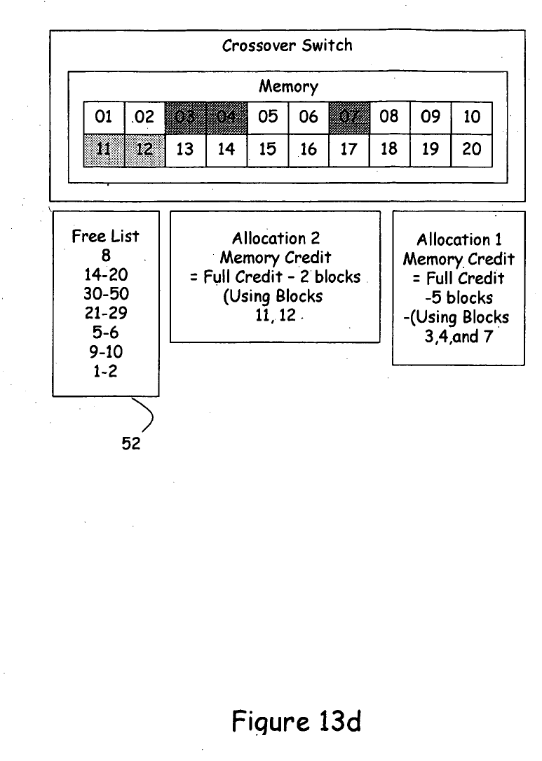

FIGS. 13a-d are schematic block diagrams of a possible memory management scheme within a crossover switch as it might exist within an exemplary storage processor in accordance with the invention. In this case, any memory management module could maintain a “heap” style memory management scheme, where memory is allocated from a free-list and linked together with pointers. When the system is finished processing the data in the memory, it may be placed back on the free-list to be used again.

FIGS. 13a-d detail such art exemplary heap-style management scheme in a crossover switch within a storage processor in accordance with the invention. In FIG. 13a, the memory locations 5-6, 9-10, and 11-12 are being used by processing one sub-unit, which has been allocated 6 blocks of memory. Accordingly, it has a credit of the full amount less the 6 blocks, as indicated in a block 52.

In FIG. 13b a request has been made for 5 blocks from the another processing sub-unit. In one embodiment, the parser may perform this request, but other modules may do this as well. Any memory management unit refers to a free list of memory blocks 52 associated within the crossover memory, and indicates to the requestor the particular 5 blocks that are to be used. The 5 blocks are then taken off the free list. In this manner, the storage need not be contiguous, but can be taken from across the memory space in the crossover switch.

In FIG. 13c, operations from the first processing sub-unit have finished on the blocks 5-6, and 9-10. Accordingly, these blocks are freed and placed on the free list. Additionally, the credit for that particular allocation is increased to represent the deallocation of the blocks.

In FIG. 13d, the second processing sub-unit has finished using the blocks 1 and 2. Accordingly, these are placed back on the free list.

In one case, the indication that the particular blocks are to be freed might come from a queue controller. However, other mechanisms can perform this function, such as any processing sub-units. It should be noted that the allocation in this example is based upon processing sub-units. These diagrams 13a-d should be exemplary to the method of the memory management, and the specific allocation may be based on other criteria other than processing sub-units, as noted previously.

In the case where the memory management is accomplished with shared memory taken from a free list of memory slots, multiple contexts for the same information may be stored as differing jobs using the same linked list of memory locations. In this manner, the memory may be allocated back to the free list when a counter indicates that the appropriate number of jobs has been processed on that stored incoming data.

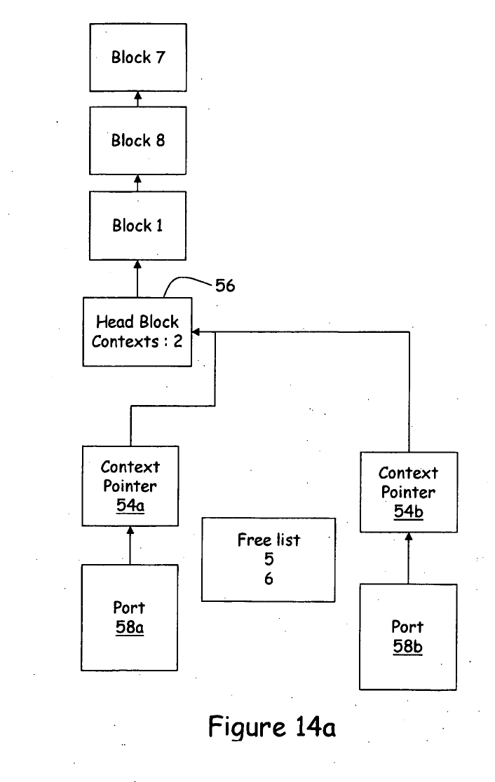

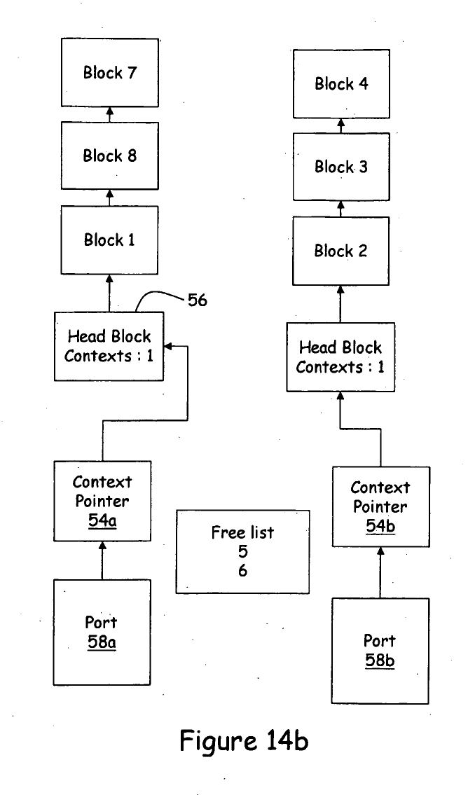

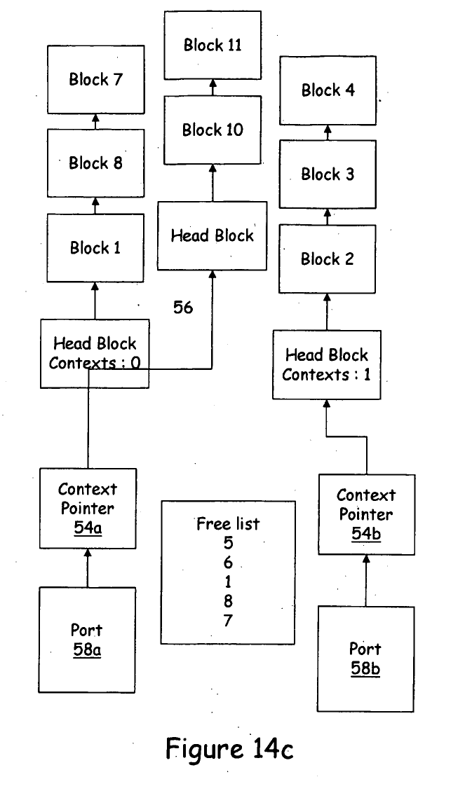

FIGS. 14a-c are data diagrams detailing a data structure and method that could be used in the mapping of multiple contexts to a series of data blocks. In this embodiment, the data blocks in question contain data and a pointer to the next block in question. In this manner, they could form a linked list that represents the data for a particular operation.

A data structure 56 contains a pointer to the beginning of the first block of the set of blocks in question and an indication of how many times the set of blocks is to be output. Using the pointer to the beginning of the first block, when a subsystem (such as a queue controller or a processing subsystem) accesses the first block, the entire set of data may be traversed. The subsystem may gain access to a portion of memory that contains information relating to the head of the block, and to the number of times that the data should be output before allowing the blocks to be freed. In this case, the data is to be output twice, as indicated in the block 56 in FIG. 14a. This would be indicative of when the functions of replication or data-splitting are performed.

In FIG. 14b, the data associated with the block 56a has been output from a port 58b. Accordingly, the information in the data structure 56 is changed to reflect that this has happened. Tins updated information is compared to the number of times that it supposed to be accessed before it is freed. In this case, the storage processor will determine that the blocks in question have not been accessed the proper number of times, and accordingly does not allow the blocks to be released.

In FIG. 14c, assume that a short time later the blocks associated with the block 56 are output a second time on the port 58a. The information associated with the number of limes the blocks have been output is changed to reflect this in the block 56a. At this point, the storage processor determines that the blocks in question have been accessed the proper number of times, and places the blocks on the free list.

The indication in the data structure may be that associated with the number of times that the block may be accessed. In this case, each lime the blocks are traversed, this number is decremented. When the number is zero, this indicates that the blocks should be freed.

In another case, the number may indicate the number of times that the blocks have been accessed. In this case, each time the blocks are traversed, this number is incremented. When the number is the number of times the data should be output, this indicates that the blocks should be freed.

This comparison can be made effective through the use of the table information. For example, at startup the table data is initiated in the storage processor. This table data tells the storage processor what to do in particular instances of data, as discussed previously (i.e. maps an input stream or request to one or more output streams).

In addition to the mapping of input ports and other criteria to output port(s) and destination(s), this also tells the storage processor how many times the stream of data should be output. Accordingly, when employing the “increment” method, this number may be placed into the data structure associated with this stream. When a set of blocks is output, the number in the data structure associated with the set of blocks is incremented and compared to this number.

The “decrement” method works in a related way, except that the number of access times is written into the data structure associated with the set of blocks at the time the blocks are written into the crossover switch. When the number in the structure associated with the set of blocks is zero, the set of blocks can be released.

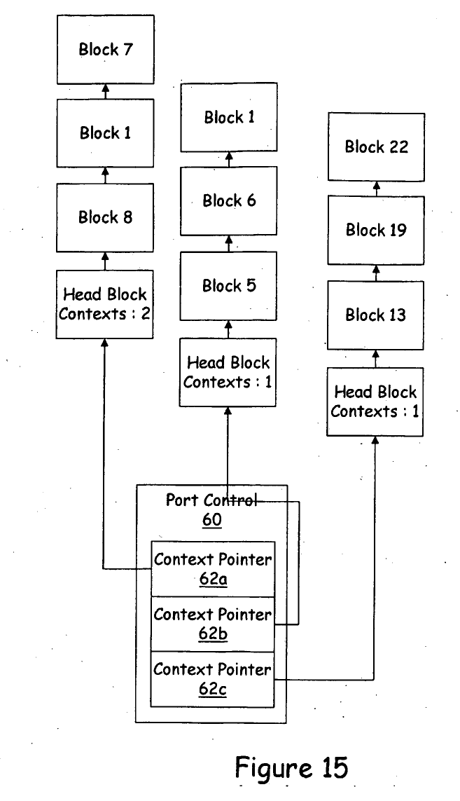

FIG. 15 is data diagram detailing the logical view of an operation of a port output control in a storage processor in accordance with the invention. In this case, a port output control 60a has access to a series of entries 62a-c representing output datagrams. This example is an array or linear collection of pointers to the data structures associated with sets of blocks to be output. The mechanism that allocates the blocks initially can place the pointers into the array, or other internal scheduling mechanisms can perform this function.

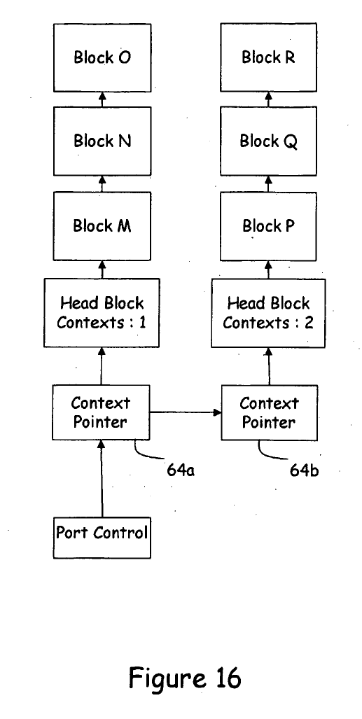

FIG. 16 is a data diagram detailing an alternative logical view of an operation of an output port control in a storage processor in accordance with the invention. In the case of FIG. 16, the port control does not operate with an array or linear collection of pointers, but as a linked list of data to one or more head nodes. In this case, the indication of the number of accesses is contained in the head node, as well as an indication to the next node associated with a set of blocks to be output, hi this case, assume that the nodes operate on the “decrement” scheme. Thus, the output port control knows that the first data to be output is associated with block M and continuing to block 0.

When the output port control receives an indication that the output associated with the block O has succeeded, the port control can decrement the number in block 64a associated with the number of times that the blocks should be output. In this case, the number would fall to zero, so the memory blocks M through O are placed on the free list.

The port control then accesses the block associated with the output block P through the output block R, and proceeds to enable their appropriate output. In this case, the blocks 64a-b can be released as well, if they reside in the memory space associated with the crossover switch.

The data associated with the output blocks (i.e. blocks 64 and 66) may also be implemented in a separate memory space. This frees the crossover switch from having to deal with the chore of maintaining the storage associated with the control queues.

In another embodiment, the output is guided by a linked list of start blocks, each having a linked list of data. In this case, both the linked list of data and the linked list of outputs can be managed as the incoming data arrives. Thus, when a new datagram comes into the storage processor, the storage processor can use the dynamic data information to create the new head, and link the first incoming block to it, then the others to the previously linked block. When the storage processor determines that the new incoming data are to be output on the same port as others, the storage processor can append the new head to the trailing head of the linked list relating to that port. In this manner, virtual output queues can be maintained internally to the crossover switch.

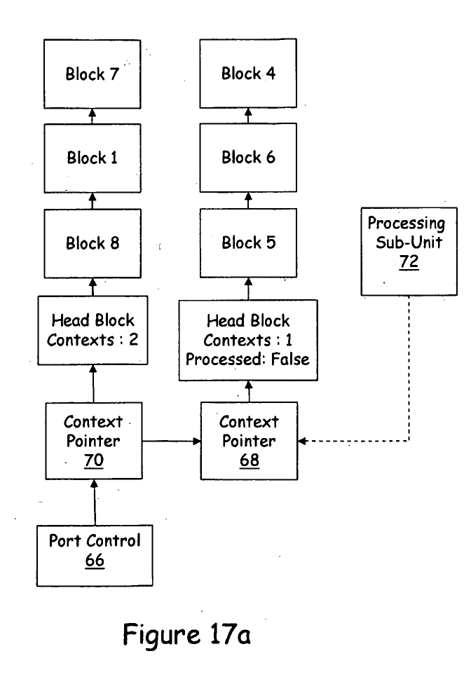

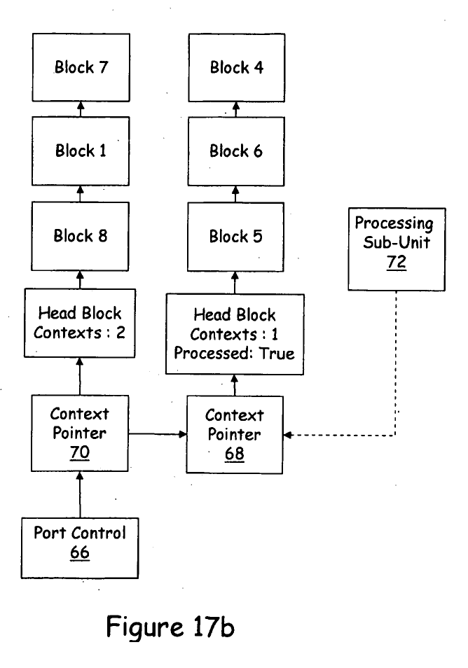

FIGS. 17a-b are data diagrams detailing how the data operations may be implemented within a crossover switch in accordance with the invention. In FIG. 17a the storage processor has placed some blocks into the crossover memory, and indicated that they are to output by a port control 66. Within the crossover switch, and according to the dynamic data information, a data header structure 68 containing the number of times the block is to be output is created. Further, data indicating whether the data is ready to be output is also created. A link is created from the last data header structure on the already existing linked list representing the port output to the new data header structure. In this manner, an output queue can be maintained in the crossover switch for each port.

In FIG. 17b, a processing sub-unit 72 accesses the data and performs actions on the data. In the course of performing those actions, it places the data in blocks of memory in the crossover switch, and has put them in a form ready for transmittal. After finishing it operations, the processing sub-unit then alters an indication within some portion of the data header structure 68, indicating that the data is capable of being transmitted. When this is appropriately altered, the port output control can send the data to the port for output.

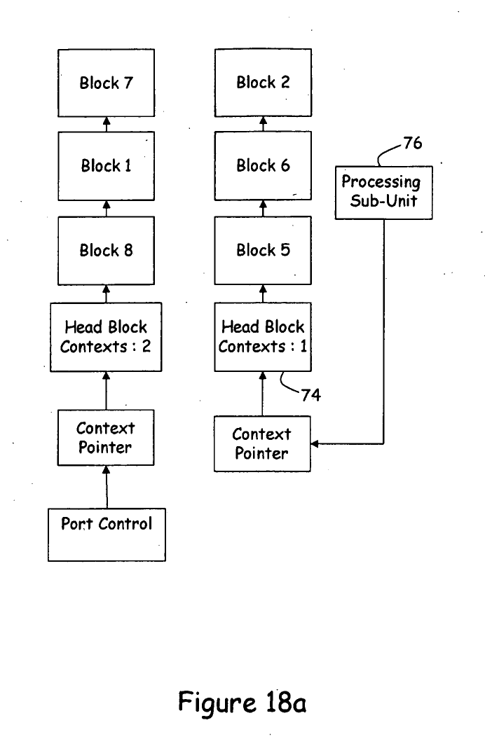

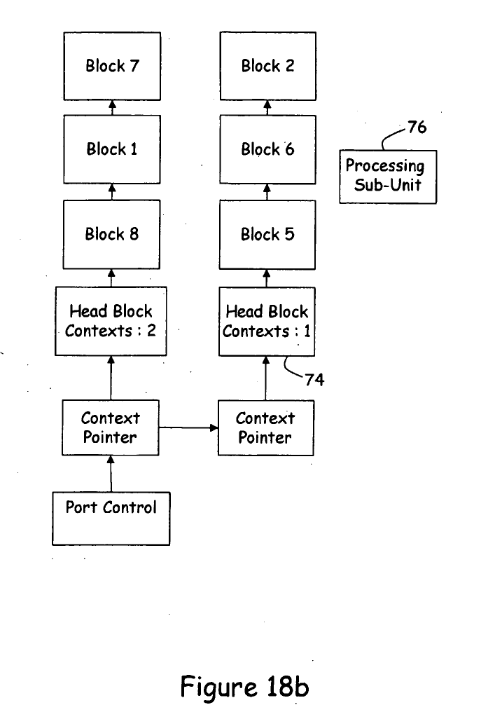

FIGS. 18a-b are data diagrams detailing alternative schemes of how the data operations may be implemented within a crossover switch in accordance with the invention. In FIG. 18a a storage processor has placed some blocks into the crossover memory. Based upon the dynamic data information, a pointer to the data header structure 74 is placed in the context of the appropriate processing sub-unit 76. In FIG. 18b, the processing sub-unit 76 has finished its operations. When this happens, the data header structure is linked to from the context of the port control. This can also be implemented with reference to the dynamic data information. The processing sub-unit can make the change of the contexts, as could the crossover switch itself.

The linked structure need not be through separate context pointers. A port control or processing sub-system can access an integrated head structure through local context pointers. The internal linkings of the data may be accomplished through the head structures pointing to one another, as opposed to separately maintained context memories.

The linked structure also allows flexibility in the How of data in and out of the storage processor. For example, assume that a data datagram is to be sent to two targets. In this case the first target is accessible through a port, and the other accessible through another port (although not required.) The storage processor can conserve resources by duplicating the pay load, but producing differing headers for each target that are stored separately. In this manner, the context count for the pay load would be 2, allowing same data pay load to be utilized as opposed to requiring that separate payloads be maintained internally. When output, the appropriate port would access the appropriate memory holding the proper datagram information for each target.

Data coherency and data integrity can become an issue when dealing with large amounts of data associated with stored datagrams. If multiple processors target memory blocks in succession, coherency of the data should be maintained. Or, assuming that data could be shunted to off-board storage and paged in, this data should also have coherency maintained. The off-board storage situation with portions being brought into the main memory upon a page fault could be applied to both the memory of the crossover switch and the memory storing the dynamic data information.

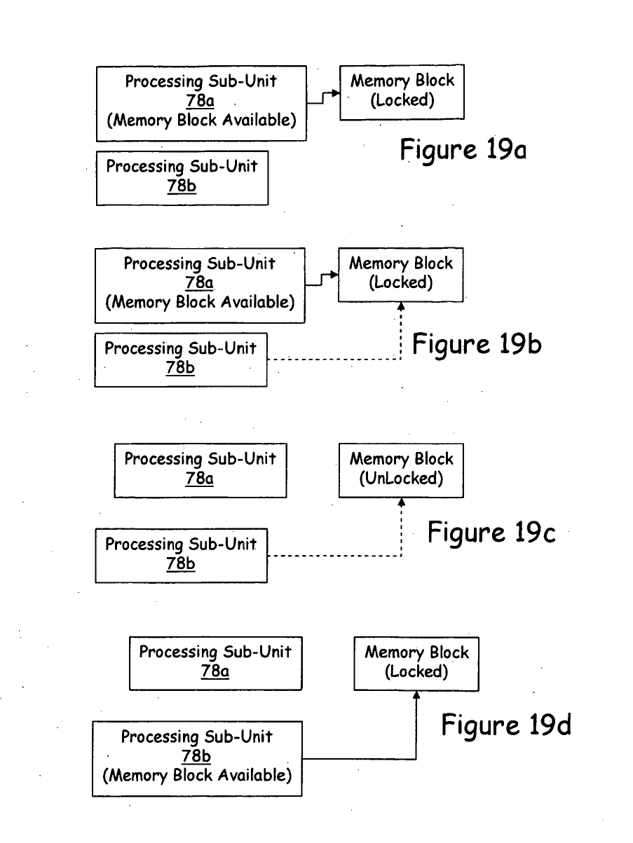

FIGS. 19a-c are logical block diagrams detailing a data coherency scheme that could be used with a storage processor in accordance with the invention. In FIG. 19a, a processing sub-unit 78a and is requesting a portion of memory. A lock is placed on the memory portions and the memory is made available to the processing sub-unit 78a. In FIG. 19b, another processing sub-unit 78b is requesting the same memory, but at a time after the request from the processing sub-unit 78a. In this case, the request from the processing sub-unit 78b is placed on hold, to ensure data coherency of the block. At a still later time, depicted in FIG. 19c, the processing sub-unit 78a has ended its write to the block and released the lock on the memory. When this happens, the request from the processing sub-unit 78b is granted, and the contents of the block are made available for reading and/or writing.

If an off-chip memory is used for storage purposes, a cache 80 may be employed to save the most recent portions of the memory that were accessed or altered. In this case, when a write occurs to a portion of memory that is to be stored off-chip, the contents of the memory could be accessed in the cache while the write is being undertaken to the off-chip storage. Since an off-chip storage action will typically take much longer than one on-chip, this cache allows the use of the contents of the memory location being written off-chip while at the same time maintaining coherency.

In an exemplar, such an off-chip paging system could be used to store the dynamic data information, since such information could easily grow to amounts that overwhelm on-chip capacity. In this case, off-chip storage can be used for much of the storage, and the pertinent information may be brought on-chip on an as-needed basis.

Note that in sonic cases (especially when the contents of the memory are not going to be written to), the locks need not be employed. In these cases, multiple accesses could be encouraged to promote efficient use of both memory resources and/or processor resources.

End to end data integrity can be accomplished through error detection schemes associated with the data. In this manner, the transmitted data is not susceptible to loss incurred in transmission.

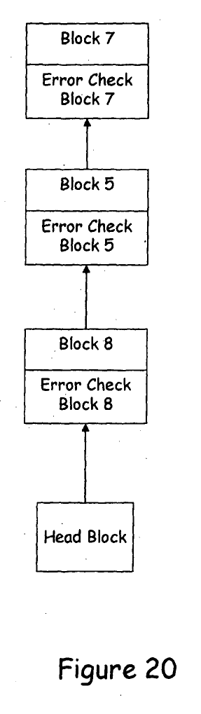

FIG. 20 is a logical block diagram detailing one such data integrity scheme associated with a storage processor in accordance with the invention. Data is stored in logical units within a memory in a crossover switch. The data can be linked by pointers between the units, as explained previously. In order to guard against data corruption within the process, an indicator of error is produced for each block. This can take the form of a checksum, or other schemes such as a cyclic redundancy checksum (CRC). Since each block associated with each package has a CRC associated with it, errors can be limited to such a block. In some other embodiments, the CRC may be changed with an error-correcting algorithm, so that errors are corrected as well as delected. Or, in the absence of error correcting schemes, when an error is detected internally to the storage processor, the storage processor may re-request the specific datagram from the source.

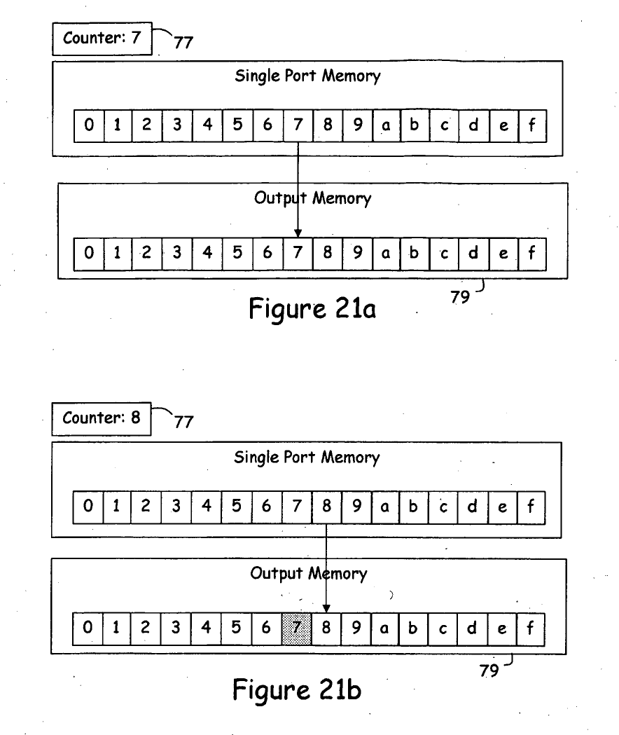

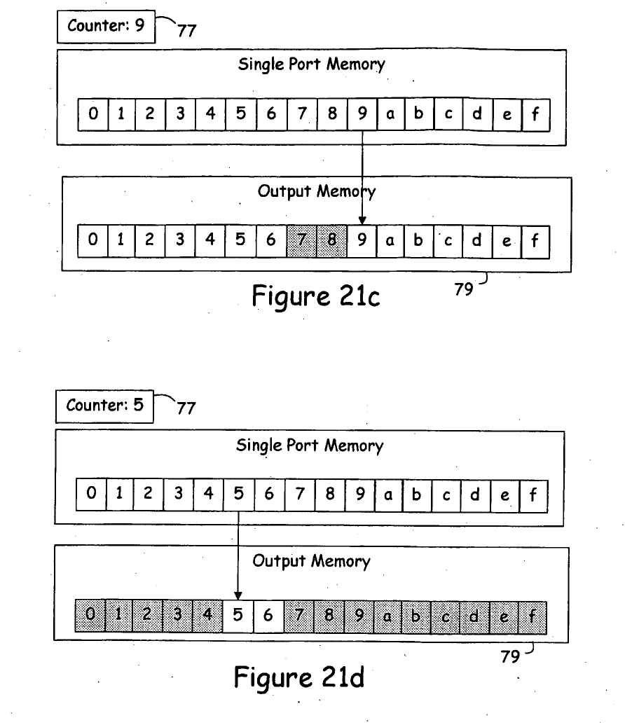

FIGS. 21a-d are schematic block diagrams detailing a memory structure that could be used in the transfer of data to an output port in a storage processor in accordance with the invention. In this embodiment, the storage processor memory can include single port memory, providing a low cost design. In order to accommodate low latency with such memory, a counter could be employed within the storage processor to aid in efficient transfer of the data to the output port. In FIG. 21a, the storage processor has just determined that the contents of the memory addresses 0-f (hexadecimal) should be transferred to an output port memory 79, for output to an external storage device. A counter 77 indicates the appropriate memory in the range that is immediately available for transfer. In FIG. 21a, the counter 77 indicates that the data in address 7 of the bank is immediately available for transfer. Address 7 does not contain the first amount of data for the output. Instead of waiting for the cycle to complete and load the contents from the beginning point, the storage processor begins to load the memory that is activated into the proper memory location that the output port can access, either in a shared memory or within memory local to the output port. In FIGS. 21b-d, succeeding memory locations are placed into the appropriate locations in the memory that the output port utilizes. This continues until the full amount of memory in the single port memory is transferred. Accordingly, this allows a low latency memory transfer between portions of the storage processor (such as the crossover switch) and the specific memories utilized by specific port driven devices (such as output ports.) hi addition, this allows the usage of single port memories in the storage processor, thus allowing the less expensive memory alternatives to be fully utilized.

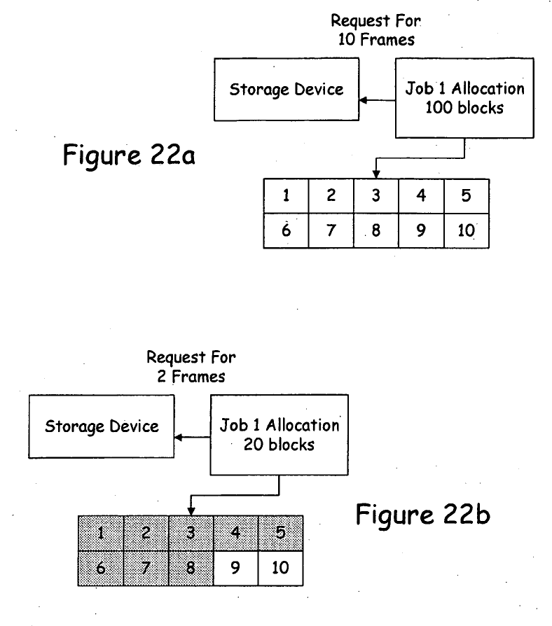

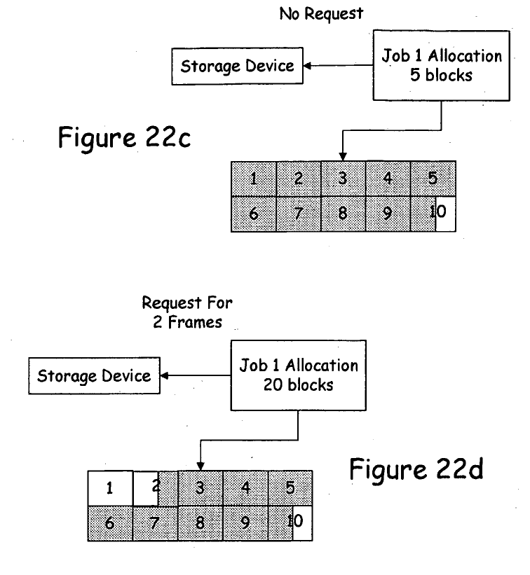

FIGS. 22a-d are schematic block diagrams of a possible memory management scheme within a crossover switch as it might exist within an exemplary storage processor in accordance with the invention. In this case, the storage processor can be used to “throttle back” and/or “speed up” transmissions from a storage device. Using this method, the storage processor can efficiently utilize the line resources available to it.

In this case, the memory management may also be used in conjunction with speed matching and speed limiting. In many storage networks, the initialization between devices on startup includes an indication of how many datagrams the remote device may send. Further, the devices typically indicate the speeds at which they can send data. This can be used to aid in speed matching aspects of the current invention.

In an exemplary case, assume that the specific stream is allocated 100 blocks of memory, representing 10 datagrams of data having the maximal amount of data. In FIG. 22a, the storage processor indicates to the storage device to send 10 datagrams of data. In response, denoted in FIG. 22b, the storage device sends the 10 datagrams of data, but at a non-maximal size. In this instance, assume that they fill only 80 blocks of memory. The storage processor can then determine that 20 blocks remain, representing 2 maximally filled datagrams. Accordingly, the storage processor then sends a request to the storage device to send 2 more datagrams.

In FIG. 22c, the 2 datagrams are received, and they fill 15 blocks, hi this instance, the storage processor will not request any more datagrams, since a maximally sized datagram will go over the 5 block remaining allocation.

However, at some future time t (FIG. 22d), assume that 15 blocks allocated to the stream have been output. The storage processor now indicates that the allotment should be incremented by 15, yielding a current allocation of 20 blocks. In response, the storage processor can request two additional datagrams, representing the 20 blocks. In this manner, the input and the output can be load balanced.

One will realize that the allocation need not be limited to a specific stream. The allocation may be made on a port-centric basis, a target-centric basis, a source centric basis. One realizes that the allocation can be tied to many differing operating parameters of the system.

The storage processor can be used to match speed characteristics of devices as well. For example, assume that a storage processor might receive a message from a first external device that the first external device operates at a speed of 4 Ghz, and that it wishes to communicate data to or from a second device. In the course of operation, the storage processor knows that the other device's operating speed is 2 GHz.

In order to optimize the through put of the system, each port of the storage processor should be used as much as possible. Accordingly, the storage processor can determine that the throughput of the first device is twice that of the second device. Accordingly, to optimize fully the usage of the output ports, the storage processor may save a parameter that indicates that the ratio of the speed of the first device to that of the second device is 2:1.

Assume that the storage processor receives a communication from the second device that it needs to send information to the first device. The storage processor can then indicate to any memory management that it should allocate a buffer of memory of a particular size. This size might proportional to the rates that the different devices operate. In this case, the allocated buffer size for transmissions from the second device to the first device is that which is equivalent to two datagrams being sent to the first device. This is due to the fact that the first device can accept one datagram of data from the storage processor the same amount of time it takes the second device to send two datagrams of data.

Accordingly, the stream from the second device to the first device via the storage processor would have two datagrams available for output. This allows the output port to be used in an efficient manner, since there will always be data to be sent, with no danger of an underflow situation. Additionally, the use of memory is more efficient, since this sets a minimal amount that should be processed for the transmission. This allows for more space to be used for other ports.

If a unitary send/receive ratio were enforced (i.e. sending a datagram from the faster device only upon the completion of the slower processing device, or vice versa), there would be the possibility of the faster system having to wait for the slower speed device on the particular input or output port. This would result in an inefficient use of resources.

Further, this buffering of the data ensures that a transmission of data out of the storage processor will not fail due to an underflow. Since the storage processor can enforce a memory buffer scheme, this also leads to the situation that one datagram is can be transmitted out of the storage processor at the same time another is being filled up. This allows concurrent transmissions between two devices to be implemented, thus leading to lower latencies in the system.

In addition, each stream may be associated with a specific allocation of memory. In this case, upon the opening of the stream between the storage processor and the external device, the device communicates to the storage processor a number of datagrams available to be sent. Internal tables can be used to internally configure each input or output stream with a certain set size of memory. The storage processor can then communicate to the external device a number of datagrams corresponding to the size of the allocated memory divided by the maximum size of the datagram. If the datagrams are smaller than the maximum size, the storage processor will then determine the remaining blocks of memory still associated with the input stream. Then, the storage processor can then request more datagrams from the origination device, again determined by the remaining buffer size divided by the maximum datagram size. This can continue until the buffer cannot accept any more datagrams. Accordingly, the origination device can be sending a data stream at its fastest communication rate for at least a certain amount of time. The stored buffer of datagram and datagram data allows the storage processor to fully utilize the outgoing ports to there fullest extent. This is important in the case where the origination device operates at a much higher rate than the destination device, since this eliminates potential bottlenecks of the faster device having to wait for the slower device to complete the request.

In one exemplary embodiment, a system can be used that enables the processing of the first parts of the datagram as it is being input into the crossover switch. In this embodiment, a mechanism in the input system (such as the parser) can determine how many layers of the datagram can be preprocessed or processed concurrently with the remainder of the datagram being input into the crossover switch. When the parser can determine that a separable portion of the datagram is present, it can direct that the processing occur on this portion prior to the rest of the datagram being present. For example, assume that a datagram is made of two layers, such as a header and a payload. In this example, when the parser determines that the header is present and available for processing, the storage processor can begin the required actions on the header portion (e.g. sending it to the appropriate processing sub-unit) while the payload portion is still being placed into the crossover switch. In order to maintain data cohesiveness, a pointer to the payload portion can be sent to the appropriate processing sub-unit as it is made available.

In this manner the incoming data can undergo any one of a number of operations. The data may be switched without processing, it may be processed and sent to an output port, or a higher level storage operation can be performed on the data through the use of the processing sub-system.

In another aspect, virtual channels could be defined at the port level. In this embodiment, a proportion of the channel bandwidth could be defined for each input or output port.

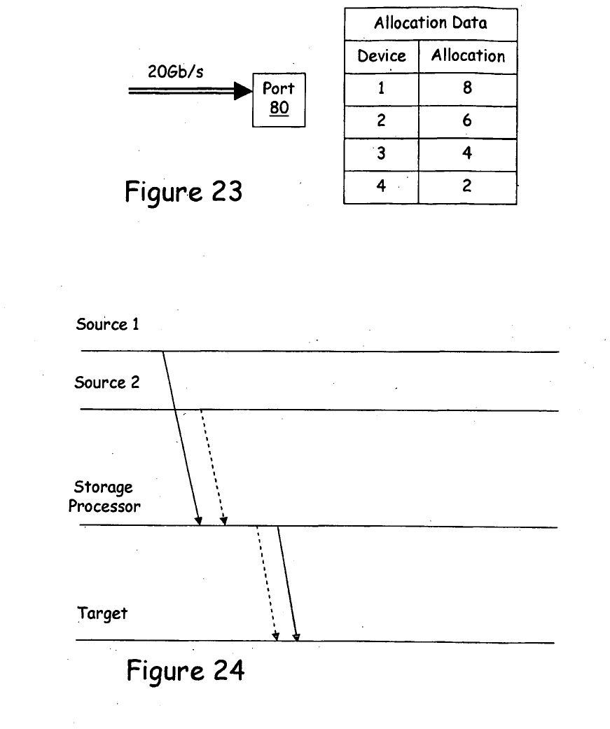

FIG. 23 is a logical block diagram detailing an exemplary allocation scheme that could be used in conjunction with a storage processor in accordance with the invention. In FIG. 22, assume that the port 80 has a bandwidth of 20 Gigabits/second (GB/s). Each of the streams associated with the port may be given a proportion of the bandwidth. In this case, information is stored that is accessible to the port 80, and this information indicates the relative proportions of bandwidth that each stream can use. In this case, the stream associated with device 1 is allocated 8 GBits/s, that associated with the device 2 is allocated 6 GBits/s, that associated with the device 3 is allocated 4 GBits/s, and that associated with the device 4 is allocated 2 GBits/s.

The streams can be those associated with physical devices, virtual storage addresses, upstream or downstream flows associated with real or virtual devices, or any combination thereof. One skilled in the art will realize that many partitioning schemes are available for such an allocation of bandwidth, and this description should be read so as to include those.

FIG. 24 is a timing diagram detailing how an exemplary storage processor in accordance with the invention can reorder datagrams. A source 90 sends data to a target at time t1 via a storage processor. At time t2, another source 92 sends data to a target (possibly the same, maybe differing) that utilizes the same output port. Assuming that the request at time t1 has not been implemented, the storage processor can determine that based upon the size of the datagrams, the relative speeds of the targets, or some other criteria (such as priority indication, or operational parameters), the storage processor can swap the outputs on the port. In this manner, the storage processor can optimize and fully utilize resources using in real-time operating characteristics.

In another embodiment, the storage processor can recognize “stale” data and react accordingly to such a situation. In this example, the storage processor may associate a timestamp with the data as it arrives at the storage processor, or as it is placed into the crossover switch. During the course of outputting the data, the storage processor can have a mechanism that compares a present time to the timestamp associated with the data. If the data is older than a certain amount, this may indicate that a message to a storage device with such data may result in a transmission error of some sort—such as a timeout error or the like. In order to conserve bandwidth, the storage processor can dynamically determine the proper course of action for such aged data. The storage processor may wait for a request to resend, then send the stored data to the requesting device. Or, the storage processor may dispose of the data in the crossover switch by placing the blocks on the free list. In this case, the storage processor anticipates that any message with the data is liable to be rejected, and accordingly saves both bandwidth resources and crossover storage resources by disposal of the data.

In this manner, the storage processor decentralizes the locus of where storage functions can be implemented. In the typical storage paradigm, these functions are implemented and/or defined within the devices running at the periphery of the path—either in the source or in the sink, or both. With the storage processor, the functionality can be defined and/or implemented at any point in the path. Thus, the functionality can be implemented at the source, at the sink, or within devices interposed between the two, or a combination thereof. Further, this allows more freedom in defining storage networks, virtual storage systems, storage provisioning, storage management, and allows scalable architectures for the implementation thereof.

Such a storage processor as described infra can have high throughput characteristics and low latency characteristics when referring to the time a datagram first appears at a port and when the first portion of a datagram leaves the storage processor bound for a destination. In a storage processor running the processing sub-units at 300 MHz, the latency between the input of the datagram and the output of the first portions of the datagram can be on the order of 10 microseconds, and can be better than 5 microseconds. Of course, these characteristics also apply to the measure of latency when the latency is defined as the last byte of the datagram in to the time of the last byte of the datagram out.

Typical throughput rates for storage processors with approximately 10 processing sub-units can be on the order of line rate (i.e. 20 Gigabits per second, input/output). Rates of 10 Gigabits per second can typically be accomplished with approximately 5 processing sub-units.

Thus, an apparatus for performing and coordinating data storage functions is described and illustrated. Those skilled in the art will recognize that many modifications and variations of the present invention are possible without departing from the invention. Of course, the various features depicted in each of the Figures and the accompanying text may be combined together. Accordingly, it should be clearly understood that the present invention is not intended to be limited by the particular features specifically described and illustrated in the drawings, but the concept of the present invention is to be measured by the scope of the appended claims. It should be understood that various changes, substitutions, and alterations could be made hereto without departing from the spirit and scope of the invention as described by the appended claims that follow.

While embodiments and applications of this invention have been shown and described, it would be apparent to those skilled in the art having the benefit of this disclosure that many more modifications than mentioned above are possible without departing from the inventive concepts herein. Further, many of the different embodiments may be combined with one another. Accordingly, the invention is not to be restricted except in the spirit of the appended claims.

Accordingly, what is claimed is:

1. A storage processor operable to communicate with one or more first and one or more second storage devices, the storage processor constructed on or within an interconnected circuit (IC) chip, the storage processor comprising:
One or more input ports, operable to receive incoming data from a first storage device;
One or more parsers, each of the one or more parsers associated with one of the one or more input ports and operable to read the incoming data;
One or more output ports, operable to send output data to a second storage device;
One or more indication circuits, each indication circuit associated with one of the one or more output ports, operable to indicate that data is ready to be transmitted to a storage device through the associated output port;
A crossover circuit, coupled to the one or more output ports and the one or more output ports, operable to store data from an input port;
A memory operable to store data that relates incoming data to an outgoing action;
A plurality of processing sub-units, coupled to the crossover circuit, operable to execute instructions on data stored in the crossover circuit;
Whereby a specific course of action is determined for a particular incoming data based upon:
i) the data in the memory relating the incoming data to an output action,
ii) a parameter found within the incoming data; or
iii) a combination of i) and ii);
Whereby a first processing sub-unit from among the plurality of processing sub-units selectively transforms the incoming data stored in the crossover circuit based upon:
i) the data in the memory relating the incoming data to an output action,
ii) a parameter found within the incoming data; or
iii) a combination of i) and ii);
Whereby a signal is actuated at a particular indicator circuit indicative that the transformed data is ready to be sent from the port which the indicator circuit is associated with; and
Whereby the associated port is operable to send the data stored in the crossover circuit to a second storage device in response to the information on the output indication circuit, the determination of the second device being at dependent upon:
i) the data in the memory relating the incoming data to an outgoing action,
ii) a parameter found within the incoming data; or
iii) a combination of i) and ii).

2. A storage processor operable to communicate with a plurality of storage devices, the storage processor constructed on or within an interconnected circuit (IC) chip, the storage processor comprising:
An input port, operable to receive incoming datagrams from a first storage device from among the plurality of storage devices;
A parser, associated with one of the one or more input ports and operable to read the incoming datagrams;
A plurality of output ports, operable to output outgoing datagrams to a second storage device;
A plurality of indication circuits, each of the plurality of indication circuits associated with an output port from among the plurality of output ports, and each indication circuit operable to indicate that an outgoing datagram is ready to be transmitted through the associated output port;
A crossover circuit, coupled to the input ports and the output ports, operable to store data from the incoming datagrams;
A memory operable to store data that relates incoming datagrams to a particular output port from among the plurality of output ports:
A processing subsystem, coupled to the crossover circuit, operable to execute instructions on the data stored in the crossover circuit;
Whereby an output datagram is output from a particular output port and to a particular storage device based upon the data in the memory relating the incoming datagram to the first output port; and
Whereby a signal is actuated at a particular indicator circuit indicative that the outgoing datagram is ready to be sent from the particular output port which the indicator circuit is associated with.

3. A storage processor operable to communicate with a plurality of storage devices, the storage processor constructed on or within an interconnected circuit (IC) chip, the storage processor comprising:
An input port, operable to receive incoming datagrams from a first storage device from among the plurality of storage devices;
A parser, associated with one of the one or more input ports and operable to read the incoming datagrams;
A plurality of output ports, operable to output outgoing datagrams to a second storage device;
A plurality of indication circuits, each of the plurality of indication circuits associated with an output port from among the plurality of output ports, and each indication circuit operable to indicate that an outgoing datagram is ready to be transmitted through the associated output port;
A crossover circuit, coupled to the input ports and the output ports, operable to store data from the incoming datagrams;
A memory operable to store data that relates incoming datagrams to a particular action to be performed;
A processing subsystem, coupled to the crossover circuit, operable to transform the data stored in the crossover circuit;
Whereby the processing subsystem selectively transforms the data in the crossover circuit based upon the data in the memory relating the incoming datagrams a particular action,
Whereby an output datagram comprising the transformed data is output from a particular output port and to a particular storage device; and
Whereby a signal is actuated at a particular indicator circuit indicative that the outgoing datagram is ready to be sent from the particular output port which the indicator circuit is associated with.
